(19) United States
(12) Patent Application Publication
(10) Pub. No.: US 2017/0095940 A1
(43) Pub. Date: Apr. 6, 2017

(54) Media Cutting Assemblies

(71) Applicant: ZIH Corp., Lincolnshire, IL (US)

(72) Inventor: Chris Colagiovanni, North Hollywood, CA (US)

(21) Appl. No.: 14/874,120

(22) Filed: Oct. 2, 2015

(51) Int. Cl. B26D 7/18; B26D 1/04

(52) U.S. Cl. CPC B26D 7/18; B26D 1/045; B26D 2007/0018

(57) ABSTRACT

Media cutting assemblies are disclosed. An example media cutting assembly includes a stationary surface extending along a plane; a circular blade to traverse the stationary surface along the plane, a portion of the circular blade being in contact with the stationary surface; and a guide to direct media along a path that interests the plane, wherein the guide extends toward the plane at a non-perpendicular angle relative to the plane.

### FIELD OF THE DISCLOSURE

This disclosure relates generally to media processing devices and, more particularly, to media cutting assemblies.

### BACKGROUND

Media processing devices process media by, for example, printing an image on a substrate of the media and/or encoding a transponder of the media. The media may be comprised of a plurality of media units (e.g., labels, receipts, tickets, radio frequency identification (RFID) tags, etc.) that are individually processed (e.g., printed on and/or encoded). Some media processing devices include one or more cutters to separate (e.g., fully or partially) the individual media units (e.g., after being printed on and/or encoder) to enable a user to remove individual ones of the media units from an output of the media processing device.

### BRIEF DESCRIPTION OF THE DRAWINGS

FIG. 1 is a block diagram of an example media processing device in which teachings of this disclosure may be implemented.

FIGS. 2A and 2B illustrate a first example type of media.

FIGS. 3A and 3B illustrate a second example type of media.

FIGS. 4A and 4B illustrate a third example type of media.

FIGS. 5A and 5B illustrate a fourth example type of media.

FIG. 6 is a schematic illustration from a first perspective of an example media cutting assembly constructed in accordance with teachings of this disclosure.

FIG. 7 is another schematic illustration from the first perspective of the example media cutting assembly of FIG. 6.

FIG. 8 is another schematic illustration from a second perspective of the example media cutting assembly of FIGS. 6 and 7.

FIG. 9 is a block diagram of an example implementation of the logic circuit of FIG. 1.

### DETAILED DESCRIPTION

Some media processing devices are capable of processing media that includes adhesive. For example, an adhesive label includes a print surface and an adhesive surface opposing the print surface. In some instances, the media includes a liner that carries the label. The liner may be referred to as a web. The liner detachably engages (e.g., via a release agent coated onto the liner) the adhesive surface to prevent the adhesive from prematurely adhering to an object. After the media is processed (e.g., printed on and/or encoder), the liner is removed by, for example, a person, an applicator, a peel mechanism, etc. Alternatively, the media is linerless. The adhesive surface of linerless media is exposed (e.g., not protected by a liner) while being processed by the media processing device.

As media including adhesive traverses through the media processing device, at least some of the adhesive may be unintendedly transferred to one or more components (e.g., devices and/or surfaces) of the media processing device during, for example, a cutting operation. The adhesive that is transferred to the component(s) of the media processing device may be referred to herein as residual adhesive. This transfer may cause an undesirable buildup of residual adhesive on the component(s) of the media processing device. For example, adhesive from the media may accumulate on one or more components of a cutting assembly tasked with separating the media units (e.g., labels) from each other and/or other surfaces of the media processing device. As the components come in contact with the adhesive of the media, some of the adhesive may remain on the components rather than being carried away by the media. Over time, the adhesive transferred to the components of the media processing device continues to accumulate and may eventually form one or more disruptive structures (e.g., balls of glue). Thus, components of the media processing device (e.g., components of a media cutting assembly) are susceptible to undesirable adhesive buildup. For example, one or more balls of glue may form at one or more points along a media feed path of the media processing device. While the potential for unwanted buildup of adhesive exists for all types of media that include adhesive, the issues are especially troublesome when processing linerless media. In particular, the linerless media traverses through the media processing device with the adhesive exposed to the components of the media processing device. Accordingly, the media processing device is more widely exposed to the adhesive of linerless media compared to media including a liner.

Residual adhesive accumulation(s) often interfere with one or more operations of the media processing device. For example, residual adhesive accumulations may reduce performance of the operation(s) and/or cause termination of the operation(s). In known systems, mitigation of this problem involves burdensome cost and labor. For example, in known systems, users of the media processing device are required to clean the media processing device to remove the residual adhesive accumulations. Cleaning procedures are inconvenient and tedious. For example, cleaning procedures may involve handling of isopropyl alcohol. Moreover, the media processing device may incur damage from improper or careless cleaning techniques and/or improper disassembly and reassembly. In some instances, the cleaning of the media processing device involves custom tools and/or materials, thereby increasing maintenance costs associated with the media processing device. Additionally or alternatively, the media processing device may require service from a technician, which may involve significant down time and/or replacement of one or more components.

Example cutting assemblies disclosed herein reduce or eliminate problems and/or complications arising from adhesive being unintendedly transferred from media being processed by a media processing device to component(s) of the media processing device. As described in detail below, example cutting assemblies disclosed herein include a moving blade that traverses along a stationary surface during a cutting operation. In examples disclosed herein, the traversal of the blade intersects a path over which the media is fed. As such, when the media is present at an intersection of the media feed path and the traversal of the blade, the blade of examples disclosed herein cuts the media. During the cutting operation of examples disclosed herein, an edge of the blade contacts adhesive of the media. As described above, problems may arise if the residual adhesive is allowed to remain and accumulate on one or more surfaces, especially if accumulation of the residual adhesive occurs in the feed path of the media.

To mitigate or eliminate such problems, example cutting assemblies disclosed herein are configured to transfer residual adhesive accumulated to a location that is out of the media feed path. In particular, examples disclosed herein transfer residual adhesive from one or more points that lie in the media feed path to a point on the stationary surface along which the blade traverses that is not in the media feed path. As such, example cutting assemblies disclosed herein prevent buildup of residual adhesive at first locations that may be problematic to second, different location(s) at which residual adhesive accumulation does not interfere with operation(s) of the media processing device. The other location(s) to which examples disclosed herein relocate the residual adhesive are sometimes referred to herein as innocuous or non-problematic.

As described in detail below, example cutting assemblies disclosed herein relocate the residual adhesive out of the media feed path to the innocuous location(s) via a movement of the moving blade along the stationary surface. In some examples, the moving blade is biased against the stationary surface via, for example, a spring. As the moving blade of examples disclosed herein moves along the stationary surface one or more points or locations on the blade contact the adhesive of the media. As the moving blade disclosed herein engages the stationary surface, the adhesive is pushed by the moving blade along the stationary surface, thereby relocating the adhesive away from the point(s) or location(s) in the media feed path to the innocuous location(s) on the stationary surface.

Additionally, examples disclosed herein include a guide that directs the media toward the blade such that the media feed path intersects the path of the moving blade at a location spaced apart from the innocuous location to which the residual adhesive is transferred. As described in detail below, the example guide components disclosed herein ensure that the media feed path is directionally oriented away from the innocuous location at which the residual adhesive accumulates. Accordingly, examples disclosed herein isolate residual adhesive accumulation from aspects of the media processing device that may be interfered with by such accumulations.

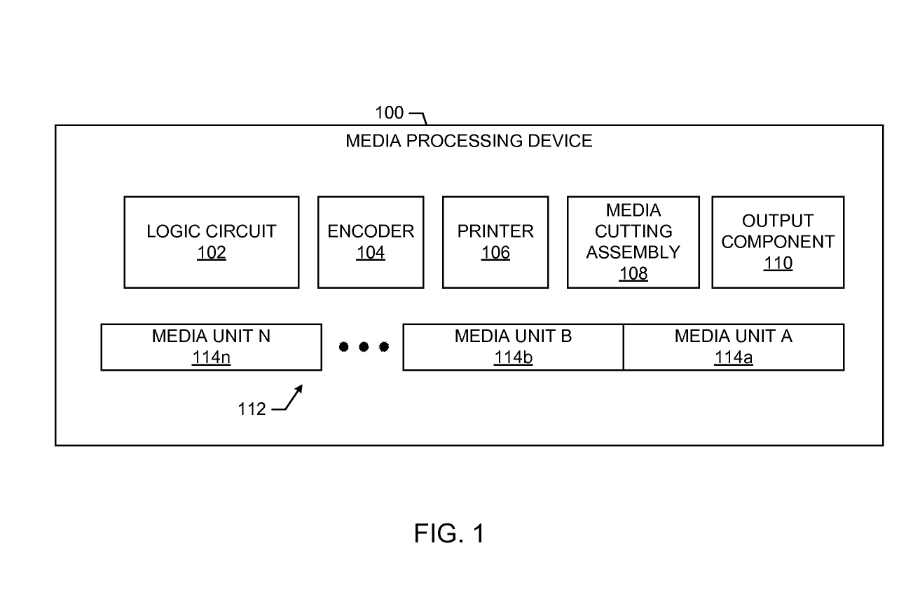

FIG. 1 is a block diagram of an example media processing device 100 in which teachings of this disclosure may be implemented. The example media processing device 100 of FIG. 1 includes a logic circuit 102 to control operations of the media processing device 100. In the example of FIG. 1, the logic circuit 102 is a physical device including at least one hardware component configured (e.g., via operation in accordance with a predetermined configuration and/or via execution of stored machine-readable instructions, such as software and/or firmware) to control one or more devices and/or perform operations of one or more devices. Examples of a logic circuit include one or more processors, one or more coprocessors, one or more microprocessors, one or more controllers, one or more digital signal processors (DSPs), one or more application specific integrated circuits (ASICs), one or more field programmable gate arrays (FPGAs), one or more microcontroller units (MCUs), one or more hardware accelerators, one or more special-purpose computer chips, and one or more system-on-a-chip (SoC) devices. Some example logic circuits, such as ASICs or FPGAs, are specifically configured hardware for performing operations. Some example logic circuits are hardware that executes machine-readable instructions (e.g., software stored on a machine-readable medium) to perform operations. Some example logic circuits include a combination of specifically configured hardware and hardware that executes machine-readable instructions. As used herein, each of the terms “tangible machine-readable medium,” “non-transitory machine-readable medium,” “machine-readable storage device” and “article of manufacture” is expressly defined as a storage medium (e.g., a platter of a hard disk drive, a digital versatile disc, a compact disc, flash memory, read-only memory, random-access memory, etc.) on which machine-readable instructions (e.g., program code in the form of, for example, software and/or firmware) can be stored. Further, as used herein, each of the terms “tangible machine-readable medium,” “non-transitory machine-readable medium,” “machine-readable storage device” and “article of manufacture” is expressly defined to exclude propagating signals. That is, as used in any claim of this patent, none of the terms “tangible machine-readable medium,” “non-transitory machine-readable medium,” “machine-readable storage device” and “article of manufacture” can be read to be implemented by a propagating signal. Further, as used herein, each of the terms “tangible machine-readable medium,” “non-transitory machine-readable medium,” “machine-readable storage device” and “article of manufacture” is expressly defined as a storage medium on which machine-readable instructions are stored for any suitable duration of time (e.g., permanently, an extended period of time (e.g., while a program associated with the machine-readable instructions is executing), and/or a short period of time (e.g., while the machine-readable instructions are cached and/or during a buffering process). As used herein, the term “at least” is open-ended in the same manner as the term “comprising” is open-ended.

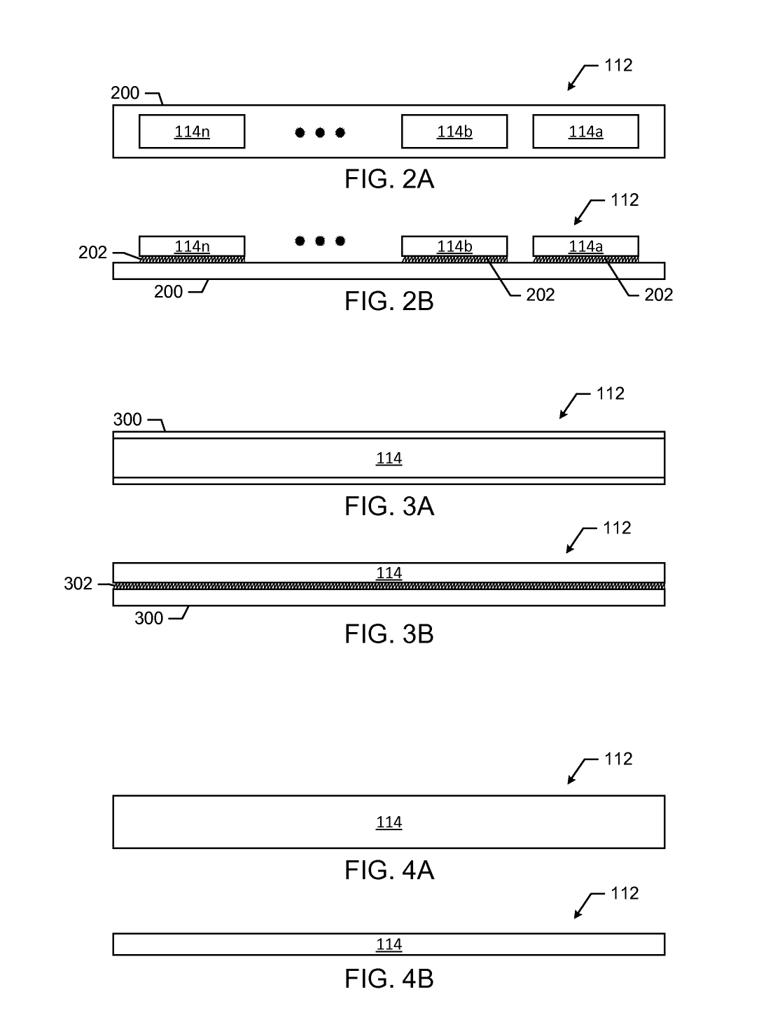

The example media processing device 100 of FIG. 1 includes an encoder 104, a printer 106, a media cutting assembly 108, and an output component 110. In the illustrated example, the media processing device 100 is provided with media 112 that includes a plurality of media units 114a-n (e.g., labels, tickets, cards, tapes, tags, inlays, transponders, RFID tags, etc.). The example media 112 can be any suitable type of media and examples disclosed herein may be utilized in connection with any suitable type of media. FIGS. 2A-5B illustrate example implementations of the media 112 and/or the media units 114a-n. The example media 112 of FIGS. 2A and 2B includes a liner 200 and the media units 114a-n are die cut units (e.g., labels). As shown in FIG. 2A, which is a bird's eye view of a print surface of the media units 114a-n, edges of the media units 114a-n are surrounded by the liner 200 (e.g., one or more dimensions of the liner 200 are greater than one or more dimensions of the individual media units 114a-n). As shown in FIG. 2B, which is a side view of the media 112, the media units 114a-n include adhesive 202. The liner 200 includes a coating such that the media units 114a-n can be removed from the liner 200 while retaining the adhesive 202. In the example of FIGS. 2A and 2B, a cutting operation may be performed at points between the die cut units. That is, the cutting operation may be performed between the media units 114a-n, which is also between the individual instances of the adhesive 202. However, at least some of the adhesive 202 may still be unintendedly transferred to, for example, a media cutting assembly during such cutting operations due to, for example, some of the adhesive 202 residing between the media units 114a-n and/or the cutting operation occurring on the edge of the media units 114a-n and/or near the edge of the media units 114a-n.

In the example of FIGS. 3A and 3B, the media 112 includes a liner 300 and a continuous media unit 114. While the example media 112 of FIGS. 3A and 3B includes the continuous media unit 114, the example media processing device 100 of FIG. 1 may separate portions of the continuous media unit 114 into individual media units (e.g., the media units 114a-n) according to, for example, one or more size indications provided by the logic circuit 102. In some examples, the media 112 includes perforations that define individual media units 114a-n. As shown in FIG. 3A, which is a bird's eye view of a print surface of the media unit 114, one or more dimensions of the liner 300 are greater than one or more dimensions of the media unit 114. As shown in FIG. 3B, which is a side view of the example media 112, the media unit 114 includes adhesive 302 initially located between the media unit 114 and the liner 300. As such, each time a cutting operation is performed on the example media 112 of FIGS. 3A and 3B, the media cutting assembly 108 contacts the adhesive 302. Accordingly, as with the example of FIGS. 2A and 2B, residual adhesive buildup is a potential issue when processing the example media 112 of FIGS. 3A and 3B.

In the example of FIGS. 4A and 4B, the media 112 does not include a liner and does not include adhesive. Instead, the example media 112 of FIGS. 4A and 4B is a continuous media unit 114. The example media 112 of FIGS. 4A and 4B may be, for example, a roll of receipts or tags. Like the examples of FIGS. 2A-3B, the example media processing device 100 of FIG. 1 is capable of processing the example media 112 of FIGS. 4A and 4B.

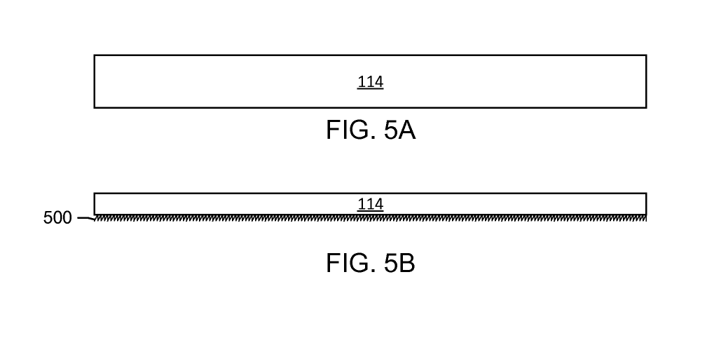

In the example of FIGS. 5A and 5B, the media 112 does not include a liner. The example media 112 of FIGS. 5A and 5B is a continuous media unit 114 that may be divided into individual units 114a-n via, for example, the media cutting assembly 108. In some examples, the media 112 is perforated to define individual media units 114a-n. As shown in FIG. 5B, the media 112 includes adhesive 500 on a surface opposing the print surface. As such, each time a cutting operation is performed on the example media 112 of FIGS. 5A and 5B, the media cutting assembly 108 contacts the adhesive 500. Accordingly, as with the example of FIGS. 2A and 2B and the example of FIGS. 3A and 3B, residual adhesive buildup is a potential issue when processing the example media 112 of FIGS. 5A and 5B.

The example media 112 of FIG. 1 is stored via a structure adapted to store and/or protect the media units 114a-n. In some examples, the media units 114a-n are stored in the storage structure in a fanfold manner. In some examples, the media 112 is stored in roll form via, for example, a spindle, a core, a hanger, etc.

The example media processing device 100 of FIG. 1 includes one or more feed components to drive the media 112 along the media feed path. In the example of FIG. 1, the feed components deliver the media 112 along the media feed path to the encoder 104 and/or the printer 106. Generally, the printer 106 is a media processor that processes the media 112 and the encoder 104 is a media processor that processes the media 112. Alternatively, the term “media processor” may refer to a combination of the encoder 104, the printer 106 and/or any other type of media processor.

The example printer 106 of FIG. 1 is any suitable type of device that causes indicia to be visible on a face of the media 112. The example printer 106 of FIG. 1 uses one or more techniques to cause the indicia to be visible on the media 112. For example, the printer 106 may utilize thermal transfer, direct thermal, ink jet, laser printing, dot matrix, dye-sublimation, and/or any other suitable technique. In some examples, the type of the media 112 to be loaded into the media processing device 100 depends on which type of technique(s) is utilized by the printer 106 to cause visual indicia to be visible on the media. In the illustrated example, the logic circuit 102 provides the printer 106 with instructions and/or data corresponding to the indicia to be printed on the media 112. The example printer 106 of FIG. 1 processes the media 112 in accordance with the received instructions and/or data.

The example encoder 104 of FIG. 1 transmits (e.g., via an antenna) electromagnetic energy into a specific zone (e.g., an interrogation zone) to write information to, for example, one or more transponders located within the zone and/or read information from, for example, the one or more transponders. For example, the encoder 104 encodes the transponder of a first one of the media units 114a with identifying information corresponding to, for example, an article (e.g., box) with which the first media units 114a is to be associated (e.g., inserted into, adhered to, etc.). Additionally or alternatively, the example encoder 104 encodes the transponder of the first one of the media units 114a with identifying information corresponding indicia printed or to be printed on the first media unit 114a by, for example, the printer 106. In the illustrated example, the logic circuit 102 provides the encoder 104 with instructions and/or data corresponding to the information to be encoded into the media units 114a-n. The example encoder 104 of FIG. 1 processes the media units 114a-n in accordance with the received instructions and/or data.

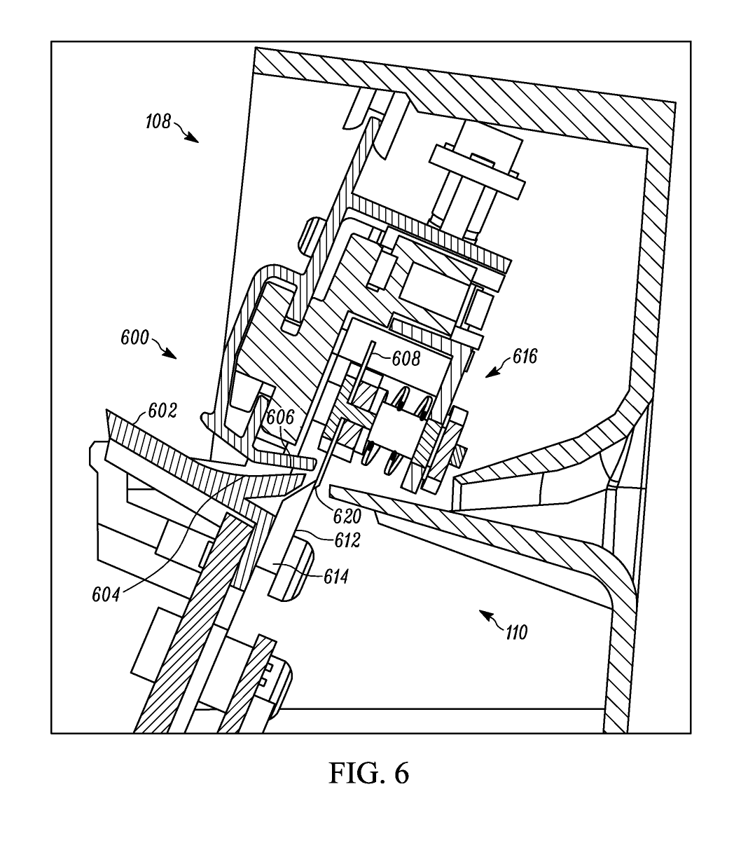

The example media processing device 100 of FIG. 1 includes a media cutting assembly 108. In the illustrated example of FIG. 1, the media cutting assembly 108 separates the media units 114a-n from each other. In some instances, the media cutting assembly 108 fully separates the media units 114a-n from each other. Alternatively, the media cutting assembly 108 may partially separate the media units 114a-n from each other. The location at which the media cutting assembly 108 of FIG. 1 cuts the media 112 is based on, for example, which type of media is currently loaded into the media processing device 100. For example, when the example die cut labels of FIGS. 2A and 2B are being processed, the example media cutting assembly 108 may cut the liner 200 between the individual media units 114a-n. Alternatively, when the example continuous media unit 114 of FIGS. 3A-5B is being processed, the example media cutting assembly 108 may receive dynamic or static instructions (e.g., from the logic circuit 102) as to locations at which cuts are to be performed (e.g., based on a size of the individual media units to be processed). An example implementation of the media cutting assembly 108 of FIG. 1 is illustrated in FIGS. 6-8 and described in detail below in connection with FIGS. 6-8.

The example media processing device 100 of FIG. 1 includes an output component 110 at which the media 112 is ejected from the media processing device 100 after the media 112 or a portion of the media 112 (e.g., one or more of the media units 114a-n) has been processed. When the media cutting assembly 108 has separated an individual one of the media units 114a-n from other ones of the media units 114a-n, the output component 110 outputs the individually separated media unit. In some examples, the output component 110 is configured to present the media units 114a-n to a person (e.g., via a slot). Additionally or alternatively, the example output component 110 of FIG. 1 prepares (e.g., positions) the media units 114a-n for adherence to an article passing by (e.g., along an inventory processing line) the media processing device 100.

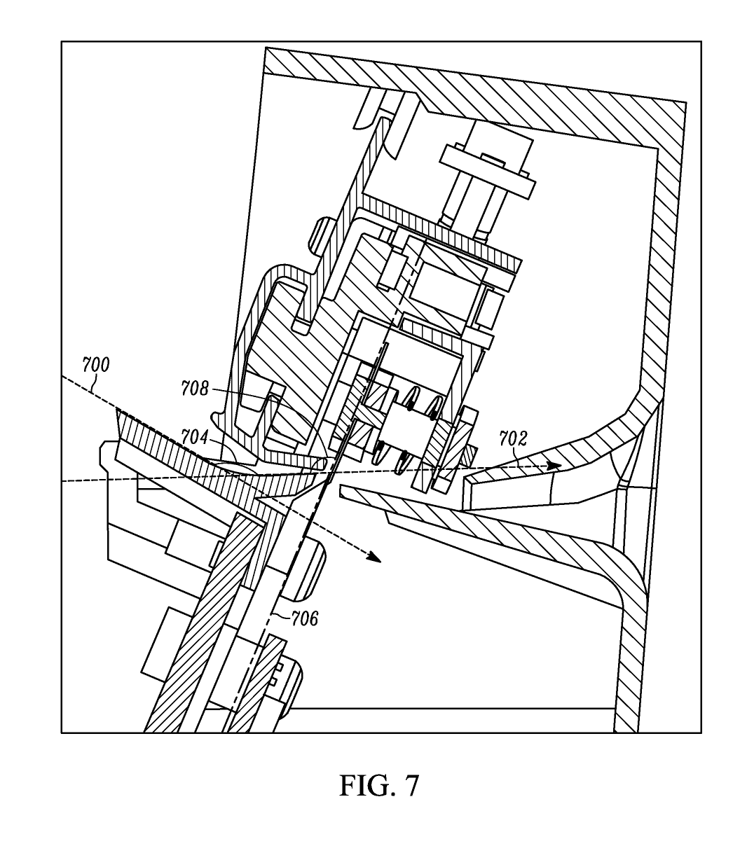

FIGS. 6 and 7 are schematic illustrations of an example implementation of the media cutting assembly 108 of FIG. 1 constructed in accordance with teachings of this disclosure. FIGS. 6 and 7 are separately provided such that certain directional and/or geometric aspects of the media cutting assembly 108 can be illustrated in FIG. 7 while maintaining clarity in FIG. 6.

The example media cutting assembly 108 of FIGS. 6 and 7 is located downstream of the encoder 104 and the printer 106. That is, the media cutting assembly 108 operates on portions of the media 112 that have already been processed by the encoder and/or the printer 106. In some instances, the media 112 undergoes a backfeed process toward the encoder 104 and the printer 106. However, downstream refers to the direction corresponding to an order in which the media 112 is processed by the different components of the media processing device 108. Accordingly, a portion of the media 112, such as the first media unit 114a, arrives at the example media cutting assembly 108 after that portion of the media 112 has been processed (e.g., printed on and/or encoded). The example media cutting assembly 108 of FIGS. 6 and 7 includes a guide 600 to direct the media 112 as the media 112 travels through the media cutting assembly 108. The example guide 600 of FIGS. 6 and 7 includes a plurality of portions, surfaces or components that direct the media 112 in different directions at different points along the media feed path. In the illustrated example, the media 112 arrives at the media cutting assembly 108 along a first guide surface 602 of the guide 600. In the illustrated example FIGS. 6 and 7, the first guide surface 602 is coated with a non-stick material such as, for example, a silicon based paint. The non-stick coating prevents the media 112 from sticking to the corresponding structure (e.g., the first guide surface 602). As shown in FIG. 7, the first guide surface 602 directs the media 112 in a first direction 700. Additionally, the example guide 600 of FIGS. 6 and 7 includes a second surface 604 downstream of the first guide surface 602. That is, the second guide surface 604 is closer to a blade 608 of the media cutting assembly 108 than the first guide surface 602. In the illustrated example, the second surface 604 is coated with a non-stick material the same as or similar to the coating on the first guide surface 602. In the illustrated example, the first guide surface 602 transitions (e.g., via a curved portion) into the second guide surface 604. In the illustrated example, the first guide surface 602, the second guide surface 604 and a transitional surface between the first and second guide surfaces 602, 604 are each part of a unitary piece of material (e.g., plastic). However, one or more portions of the guide 600 may be separate pieces that are joined (e.g., during assembly and/or manufacture). As shown in FIG. 7, the second guide surface 604 directs the media 112 in a second direction 702 different than the first direction 700. As shown in FIG. 7, the first direction 700 is arranged at a non-zero, non-perpendicular angle 704 relative to the second direction 702. Put another way, the example second guide surface 604 ramps (e.g., inclines or declines, depending on a current orientation) relative to the first guide surface 602.

The example guide 600 of FIGS. 6 and 7 includes a third guide surface 606. Like the first and second guide surfaces 602, 604, the example third guide surface 606 is coated with a non-stick material in the illustrated example. The example third guide surface 606 opposes the second guide surface 604. The example third guide surface 606 of FIG. 6 extends beyond an end of the second guide surface 604 proximate the blade 608. In conjunction with the second guide surface 604, the example third guide surface 606 directs the media 112 toward the blade 608 of the example media cutting assembly 108. In particular, the example second guide surface 604 directs the media in the second direction 702 and the example third guide surface 606 forces the media towards the blade 608. In some instances, the media has a curling tendency and the third guide surface 606 breaks the curl and forces the media towards the blade 608 such that the media is cut at a suitable location and at a suitable angle. In the illustrated example, there is a gap between an end of the first guide surface 602 and the blade 608. Further, there is a gap between an end of the third guide surface 606 and the blade 608. The gap between the ends of the guide surfaces 602, 604 and the blade 608 prevents visible bending in the media being processing. Moreover, the gap between prevents unwanted artifact from being printed on the media being processed.

The example blade 608 of FIGS. 6 and 7 is a circular blade having a distal end along a circumference. As shown in FIG. 7, the example blade 608 defines a plane 706. The example blade 608 of FIGS. 6 and 7 is driven (e.g., via an actuator) to move back and forth along the plane 706 and through the media feed path to separate, for example, individual ones of the media units 114a-n from each other. As such, the example plane 706 of FIG. 7 is referred to herein as a cutting plane. In particular, the blade 608 cuts the media 112 at points that define edges of the individual media units 114a-n.

The example blade 608 of FIGS. 6 and 7 frictionally engages a stationary surface 612 of a frame component 614. As shown in FIG. 7, the example blade 608 and the example stationary surface 612 of FIGS. 6 and 7 are in contact along the cutting plane 706. In the illustrated example, the cutting plane 706 defined by the blade 608 and the stationary surface 612 intersects the second direction 702 associated with the second guide surface 604 at a non-zero, non-perpendicular cutting angle 708 relative to the second direction 702. That is, the second guide surface 604 and, thus, the second direction 702 extend toward the cutting plane 706 at the non-zero, non-perpendicular cutting angle 708. As such, the media feed path intersects the cutting plane 706 at the non-zero, non-perpendicular cutting angle 708. After being cut by the blade 608, the media 112 arrives at the output component 110 and may be removed from the media processing device 100. In the illustrated example, the output component 110 is a slot through which the media 112 is fed for retrieval by, for example, a person, an auto-applicator (e.g., a blower, a tamper, etc.).

In the example of FIGS. 6 and 7, the media cutting assembly 108 includes a biasing element 616 that applies a force against the blade 608 in a direction toward the stationary surface 612. In the illustrated example, the biasing element 616 includes a spring that engages the blade 608. In the illustrated example, parameters of the spring (e.g., length and K value) are selected based on empirical testing. In some examples, the spring is fixedly mounted in the biasing element 616. Alternatively, the example biasing element 616 may include an adjustment mechanism to control an amount of force applied to the blade 608 by the spring. In such instances, the adjustment mechanism may be used to alter an amount of force being applied by the spring.

During the traversal of the blade 608 along the stationary surface 612, points and/or areas of the blade 608 (e.g., at locations on or near the distal end along the circumference of the blade 608) travel along the stationary surface 612 at an accumulation axis 620 extending along the stationary surface 612. In the illustrated example, the blade 608 rotates as the blade 608 traverses the stationary surface 612. In some examples, the rotation of the blade 608 is driven (e.g., by a motor). Alternatively, the rotation of the blade 608 is not driven by a rotation actuator. Instead, the rotation of the blade 608 may occur as a result of the traversal along the stationary surface 612. As the blade 608 moves along the stationary surface 612, different points along the blade 608 are proximate the accumulation axis 620 or in contact with point along the accumulation axis 620. As a result, adhesive of the media that was contacted by the blade 608 is moved or transferred to the stationary surface 612 along the accumulation axis 620.

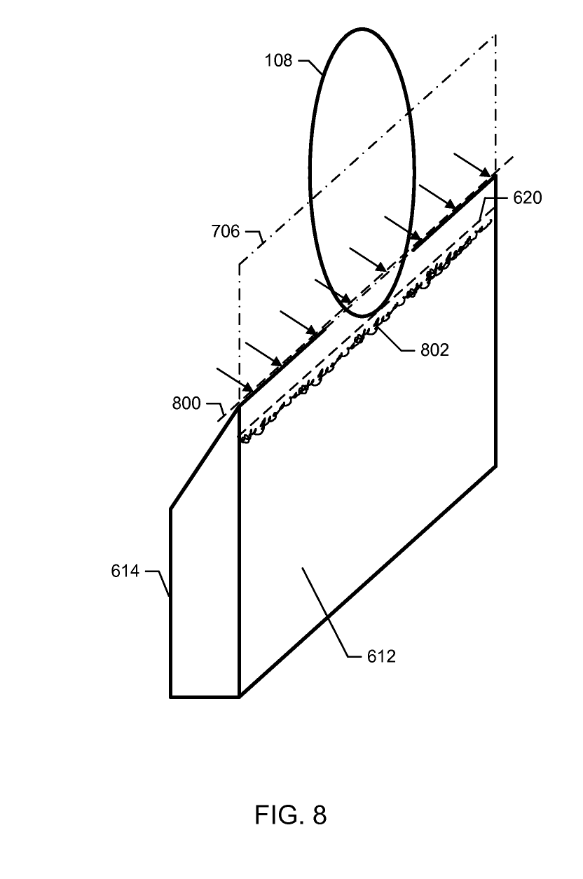

FIG. 8 is an isometric illustration of the blade 608 and the stationary surface 612 of the frame component 614. As shown in FIG. 8, the accumulation axis 620 is spaced apart (e.g., by a distance corresponding to an amount of overlap between the blade 608 and the stationary surface 612) from a cutting axis 800 at which the media feed path (indicated with arrows in FIG. 8) intersects the cutting plane 706. Put another way, the accumulation axis 620 is spaced apart from the cutting axis 800 along the cutting plane 706. In the illustrated example, the cutting axis 800 corresponds an edge of the stationary surface 612. Thus, the points along the stationary surface 612 to which residual adhesive 802 is moved or transferred are spaced apart from the location in the media cutting assembly 108 at which the media 112 is cut by the blade 608.

As the residual adhesive 802 is relocated to such an innocuous or non-problematic location (e.g., one or more points along the accumulation axis 620), potential negative effects of unwanted buildup of adhesive are reduced or eliminated by the example media cutting assembly 108 of FIGS. 6 and 7. For example, if adhesive is present along the cutting axis 800, the blade 608 pushes the adhesive away from the cutting axis 800 and toward the accumulation axis 620 due to the configuration of the example media cutting assembly 108.

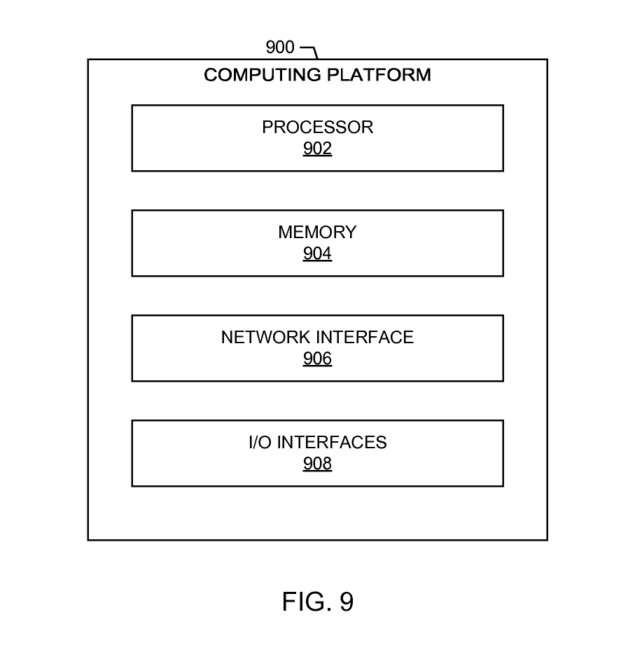

FIG. 9 is a block diagram representative of an example logic circuit that may utilized to implement, for example, the logic circuit 102 of FIG. 1. The example logic circuit of FIG. 9 is a computing platform 900 capable of executing instructions to, for example, control the printer 106 of FIG. 1, the encoder 104 of FIG. 1, and/or the example media cutting assembly 108 of FIGS. 1 and/or 6-7.

The example computing platform 900 of FIG. 9 includes a processor 902 such as, for example, one or more microprocessors, controllers, and/or any suitable type of processor. The example computing platform 900 of FIG. 9 includes memory (e.g., volatile memory, non-volatile memory) accessible by the processor 902 (e.g., via a memory controller). The example processor 902 interacts with the memory 904 to obtain, for example, machine-readable instructions stored in the memory 904 that are associated with the printer 106 of FIG. 1, the encoder 104 of FIG. 1, and/or the example media cutting assembly 108 of FIGS. 1 and/or 6-7. Additionally or alternatively, machine-readable instructions associated with the printer 106 of FIG. 1, the encoder 104 of FIG. 1, and/or the example media cutting assembly 108 of FIGS. 1 and/or 6-7 may be stored on one or more removable media (e.g., a compact disc, a digital versatile disc, removable flash memory, etc.) that may be coupled to the computing platform 900 to provide access to the machine-readable instructions stored thereon.

The example computing platform 900 of FIG. 9 includes a network interface 906 to enable communication with other machines via, for example, one or more networks. The example network interface 906 includes any suitable type of communication interface(s) (e.g., wired and/or wireless interfaces) configured to operate in accordance with any suitable protocol(s).

The example computing platform 900 of FIG. 9 includes input/output (I/O) interfaces 908 to enable receipt of user input and communication of output data to the user.

Although certain example apparatus, methods, and articles of manufacture have been disclosed herein, the scope of coverage of this patent is not limited thereto. On the contrary, this patent covers all apparatus, methods, and articles of manufacture fairly falling within the scope of the claims of this patent.

What is claimed is:

1. A media cutting assembly, comprising:
a stationary surface extending along a plane;
a circular blade to traverse the stationary surface along the plane, a portion of the circular blade being in contact with the stationary surface; and
a guide to direct media along a path that interests the plane, wherein the guide extends toward the plane at a non-perpendicular angle relative to the plane.

2. A media cutting assembly as defined in claim 1, wherein a distal end of the circular blade travels along the stationary surface proximate an accumulation axis.

3. A media cutting assembly as defined in claim 2, wherein the path intersects the plane along a second axis different than the accumulation axis, and the second axis is spaced apart from the accumulation axis along the plane.

4. A media cutting assembly as defined in claim 1, further comprising a biasing element to bias the circular blade against the stationary surface.

5. A media cutting assembly as defined in claim 1, wherein the circular blade is to transfer adhesive away from a cutting axis toward an accumulation axis of the stationary surface.

6. A media cutting assembly as defined in claim 1, further comprising a coating on the guide.

7. A media cutting assembly as defined in claim 6, wherein the coating comprises a silicone paint.

8. An apparatus, comprising:
a media processor to process media;
a blade to cut the media at a first location along a path through which the media is directed by a guide, wherein the guide is to direct the media toward the first location in a direction, the direction being at a non-perpendicular angle relative to a plane defined by the blade; and
an adhesive accumulation surface having an accumulation axis at a second location, the first location being separated from the second location by a distance.

9. An apparatus as defined in claim 8, wherein the blade is to move adhesive of the media away from the first location toward the second location.

10. An apparatus as defined in claim 8, further comprising an actuator to move the blade along the adhesive accumulation surface in a second direction that intersects the path through which the media is directed.

11. An apparatus as defined in claim 8, further comprising a non-stick coating on the guide.

12. An apparatus as defined in claim 8, wherein a first portion of the blade overlaps with a second portion of the adhesive accumulation surface as the blade traverses along the adhesive accumulation surface.

13. An apparatus as defined in claim 8, wherein the blade is circular and the adhesive accumulation surface is coplanar with the circular blade.

14. An apparatus as defined in claim 8, further comprising a logic circuit to control operations of the media processor and traversal of the blade along the adhesive accumulation surface.

15. A frame for a media processing device, the frame comprising:
a first surface to direct media in a first direction, the first portion being downstream of a media processor; and
a second surface downstream of the first surface, the second surface to direct the media in a second direction at a first angle relative to the first direction, the second direction being at a non-perpendicular angle relative to a plane defined by a blade of a cutting assembly.

16. A frame as defined in claim 15, further comprising a stationary surface to engage the blade along the plane defined by the blade.

17. A frame as defined in claim 16, wherein the second surface directs the media to a first location spaced apart from a second location on the stationary surface at which adhesive is to accumulate.

18. A frame as defined in claim 15, further comprising a third surface opposing the second surface.

19. A frame as defined in claim 18, wherein the third surface directs the media in a third direction toward the plane defined by the blade of the cutting assembly.

20. A frame as defined in claim 15, wherein the blade of the cutting assembly is downstream of the first surface and the second surface.
